(19) United States
(12) Patent Application Publication
(10) Pub. No.: US 2025/0378782 A1
(43) Pub. Date: Dec. 11, 2025

(54) PULSE WIDTH MODULATION (PWM) FOR DISPLAYS

(71) Applicant: Tectus Corporation, Cupertino, CA (US)

(72) Inventors: Cary Loren Delano, Los Altos, CA (US); Pritika Dandriyal, San Jose, CA (US)

(21) Appl. No.: 19/228,035

(22) Filed: Jun. 4, 2025

Related U.S. Application Data
(60) Provisional application No. 63/656,930, filed on Jun. 6, 2024.

(51) Int. Cl. G09G 3/32

(52) U.S. Cl. CPC G09G 3/32; G09G 2310/08; G09G 2320/064; G09G 2330/021

(57) ABSTRACT

Pulse width modulation is used to drive pixels in a video display. Bit codes are received for pulses that drive at least two different pixels of a video display. The bit codes specify which pulses are on or off within illumination windows for the pixels. The illumination windows for the different pixels are temporally aligned. Pulses are generated from the bit codes. The order of the pulses within the illumination windows is different for the different pixels.

### CROSS-REFERENCE TO RELATED APPLICATIONS

This application claims priority under 35 U.S.C. § 119(e) to U.S. Provisional Patent Application Serial No. 63/656,930, “Optimized PWM patterns for micro-LED displays,” filed June 6, 2025. The subject matter of all of the foregoing is incorporated herein by reference in its entirety.

### BACKGROUND

### 1. TECHNICAL FIELD

This disclosure relates generally to pulse width modulation used to drive displays.

### 2. DESCRIPTION OF RELATED ART

Demand for displays, for televisions, tablets, cell phones and future applications such as augmented reality glasses, is insatiable. Small, bright and efficient color displays, better than those that exist today, would be very valuable. For many applications, displays based on micro light emitting diodes (“micro-LED” or “µLED”) driven by pulse width modulated signals are promising candidates.

### BRIEF DESCRIPTION OF THE DRAWINGS

Embodiments of the disclosure have other advantages and features which will be more readily apparent from the following detailed description and the appended claims, when taken in conjunction with the examples in the accompanying drawings, in which:

FIG. 1 shows timing diagrams illustrating the concept of pulse ordering.

FIG. 2 shows timing diagrams illustrating a set of different pulse orders for different pixels.

FIGS. 3A-3C are plots of supply current over time, comparing temporally aligned and non-aligned pulse orders.

FIG. 4 shows timing diagrams illustrating another set of different pulse orders for different pixels.

FIG. 5 shows timing diagrams illustrating accelerated illumination.

FIG. 6 is a plot of supply voltage over time, comparing non-accelerated and accelerated illumination.

FIG. 7 is a block diagram of a video display chip using non-aligned pulse orders.

### DETAILED DESCRIPTION OF THE PREFERRED EMBODIMENTS

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

This disclosure relates to pulse width modulation (PWM) patterns for displays. The displays are constructed as arrays of individually controllable pixels. For example, a color display may include a 1920 x 1080 array of color pixels, each of which has individually driven red, green and blue light elements. Individual pixels may be based on LEDs, including micro-LEDs. The brightness of the pixels in the display may be modulated in various ways.

In one scheme, the brightness of individual pixels is controlled by pulse width modulation (PWM) of the LED drive current. In video displays, the brightness of pixels is updated according to the frame rate of the display. Each frame lasts for some temporal duration, also known as the frame period. The pixel may be illuminated for all or some portion of the frame period, which is referred to as the illumination window. PWM controls the brightness by changing the time period during which the pixel is illuminated.

Control signals specify the duration of the illumination. In one approach, the control signals are bit codes. For example, a 12-bit code may be used to specify 2¹² = 4096 different durations, with a bit code of all 1’s (111111111111) representing maximum brightness and a bit code of all 0’s (000000000000) representing minimum brightness. The bit code may be linear, meaning that the LEDs are illuminated for a duration of 2ⁿ(Δ) where n is the number represented by the bit code and Δ is some unit width. For a 12-bit code, the illumination would then range from a duration of 0Δ to a duration of 4095Δ in steps of Δ. The bit code may also be non-linear, meaning that the incremental durations added by adjacent bit codes may not all be equal.

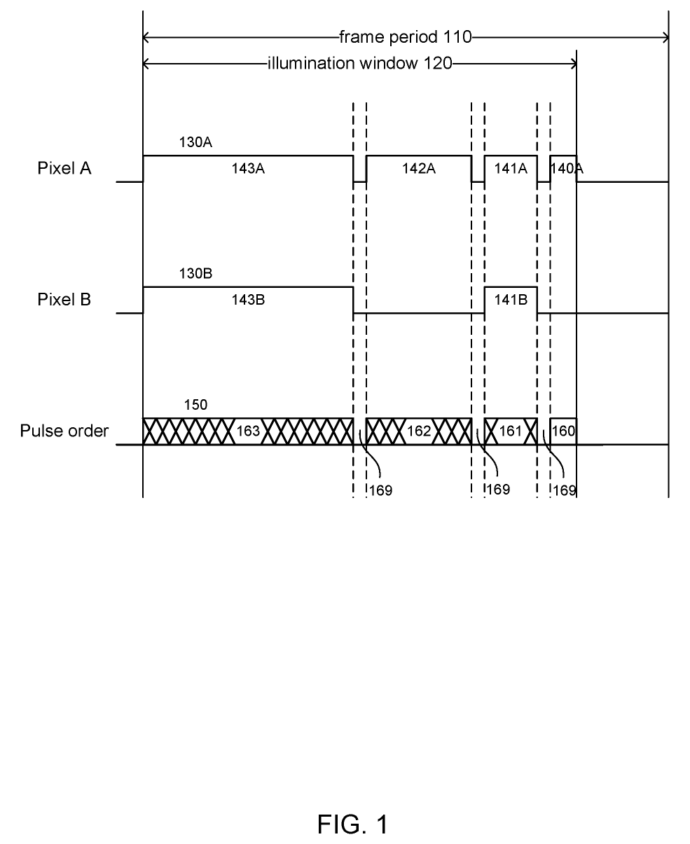

FIG. 1 shows one approach to PWM using bit codes. A 4-bit code is used in this example. FIG. 1 shows one frame period 110 (1/frame rate) and the illumination window 120 within that frame period. The drive signal 130A for each frame period can have a width of 0Δ up to 15Δ depending on the bit code. The drive signal 130A includes a pattern of pulses 140A-143A within the illumination window. Each pulse corresponds to one bit in the bit code. The bit code for pixel A is 1111, which is maximum brightness. As a result, the drive signal 130A for pixel A includes four pulses 140A-143A. Pulse 140A corresponds to the least significant bit b0 and has some time duration Δ. Pulses 141A, 142A, 143A correspond to bits b1, b2, b3 and have durations 2Δ, 4Δ, 8Δ. The pulses 140A-143A are separated by gaps. The total duration of drive signal 130A is 15A.

The bit code for pixel B is 1010 and the corresponding drive signal 130B is shown in FIG. 1. According to the bit code, drive signal 130B includes pulses 141B and 143B which are on, while the pulses for the other bits are off. Since the two pixels A and B are using the same PWM pulse pattern (i.e. same pulse order and timing of pulses) within the same illumination window, the pulses for pixels A and B are temporally aligned.

The bottom row of FIG. 1 shows the pulse order 150 used by both pixels A and B in FIG. 1. The pulse order is b3-b2-b1-b0, meaning that the pulse for bit b3 is followed by the pulses for bits b2, b1 and b0, respectively. The timing pattern for this pulse order includes time slots 160-163 for the pulses corresponding to the bits in the bit code. Time slot 163 is for the pulse of the most significant bit and time slot 160 is for the pulse for the least significant bit. The time slots are separated by gap periods 169. The timing pattern is fast enough that the eye’s slow response time integrates the incoming light to provide an impression of an overall brightness level.

FIG. 1 shows pulses for a single frame for pixel A and for pixel B, but there will be multiple frames for each pixel using the same PWM pulse pattern shown in FIG. 1. If many, or most, of the pixels in a display are operating at high brightness, the display as a whole may draw a significant current. For example, a 2280x1750 pixel display which draws up to 3µA per pixel, draws 12A overall if all the pixels are turned on at maximum brightness. That current level cannot be supplied by a typical display power supply and could overheat a display chip. Even in more typical scenarios, where the total display current draw is, e.g. 1A, a typical display power supply may not be able to maintain constant voltage during periods of high current demand.

The power supply problem is accentuated when similar or identical bit codes are sent to many or all pixels in a display simultaneously and when the pixels use the same or similar PWM pulse patterns within the same illumination window. In FIG. 1, if all pixels used the same pulse order 150, then there would be a large current draw for approximately half the illumination window if many bit codes started with 1, regardless of the last 3 bits.

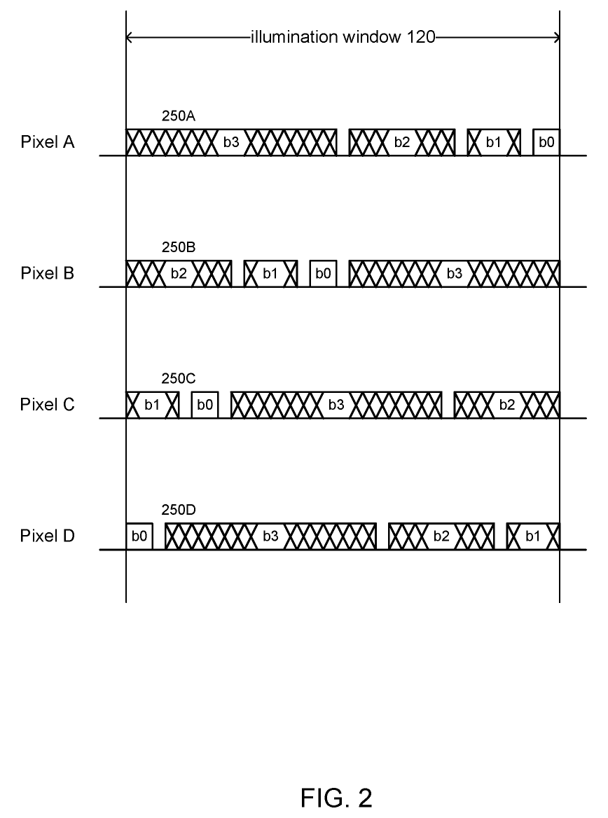

One way to mitigate this problem is to use different PWM pulse patterns (e.g., different pulse orders) for different pixels. In FIG. 2, different pulse orders are used for pixels A-D. In this example, the pulse order is shifted by one pulse per pixel (i.e., from pixel A to pixel B to pixel C to pixel D). The pulse order 250A for pixel A is the same as in FIG. 1. It contains time slots for bits b3-b2-b1-b0 in that order. The pulse order 250B for pixel B is shifted to the left by one pulse, so the pulse order is b2-b1-b0-b3. Similarly, the pulse orders 250C and 250D for pixels C and D are b1-b0-b3-b2 and b0-b3-b2-b1.

In this case, the overall current draw from the display is spread more evenly over time. Even if bit b3 is 1 for all pixels, the corresponding pulses are not temporally aligned for every pixel. The peak current draw and/or the duration of peak current draw can be reduced. This less stringent situation can be more easily addressed with coupling capacitors, for example.

In some cases, the same pulse order may be used for a group of pixels. For example, the same pulse order may be used for all pixels in a row of the display. Pulse order 250A may be used for all pixels in row j of the display, and pulse orders 250B,C,D used for all pixels in adjacent rows (j+1), (j+2), (j+3), respectively. As another example, the same pulse order may be used for all pixels in a set of adjacent rows of the display.

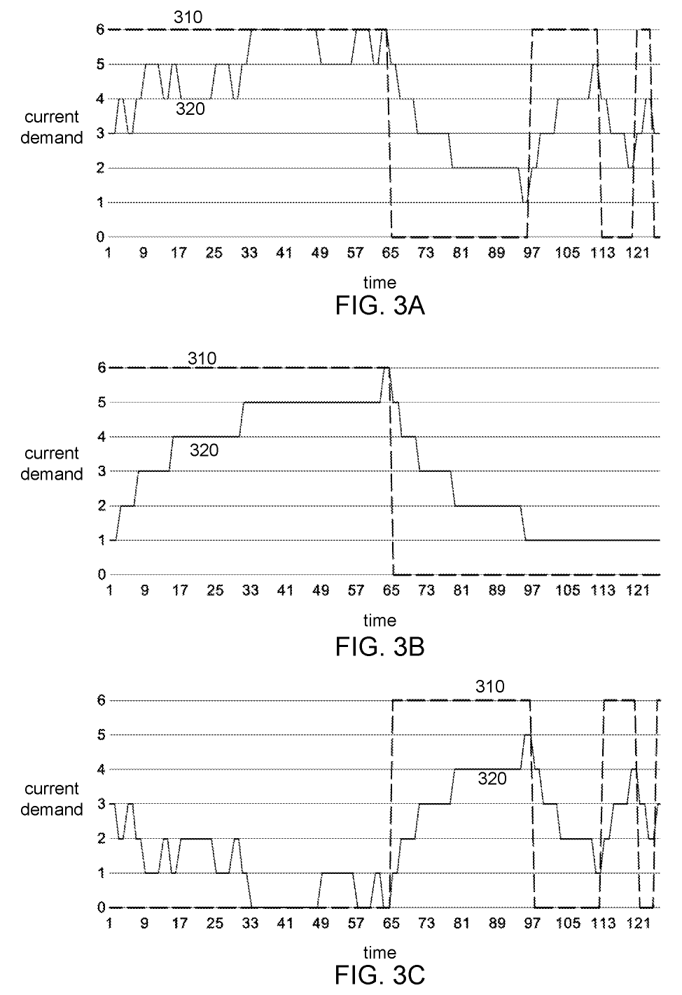

FIGS. 3A-3C show the effect of using different pulse orders. The figures plot current demand as a function of time over one frame. Each figure shows a different 6-bit code. The bit codes are 101010, 100000, and 010101 for FIGS. 3A, 3B and 3C, respectively. The x-axis is time. The period Δx=2 is the duration of the shortest pulse which is for bit b0, and Δx=64 is the duration of the longest pulse which is for bit b5. The figures show simulated results for six groups of pixels. Current demand (y-axis) is expressed as multiples of the maximum current draw for one pixel. That is, y=1 is the current draw when only one group of pixels is on, and y=6 is the current draw when all six groups of pixels are on.

The dashed line 310 in each figure plots the current demand for a design in which all six groups of pixels use the same aligned pulse order, as described in FIG. 1. The current draw toggles between 0 when the bit code = 0 for all pixel groups and 6 when the bit code = 1 for all pixel groups.

The solid line 320 in each figure plots the current demand for a design in which each group of pixels uses a circularly shifting pulse order, as described in FIG. 2. The duration of peak current for the case using non-aligned pulse orders is less than that for the case using aligned pulse orders. Thus the current demand is spread out temporally and more easily may remain within the capabilities of the power supply.

Non-aligned pulse orders may be achieved in many different ways. As another variation, rather than shifting each pulse order by a single pulse for adjacent pixels, the shift may be randomized. Pulse orders for different groups of pixels may be shifted by a random number of pulses.

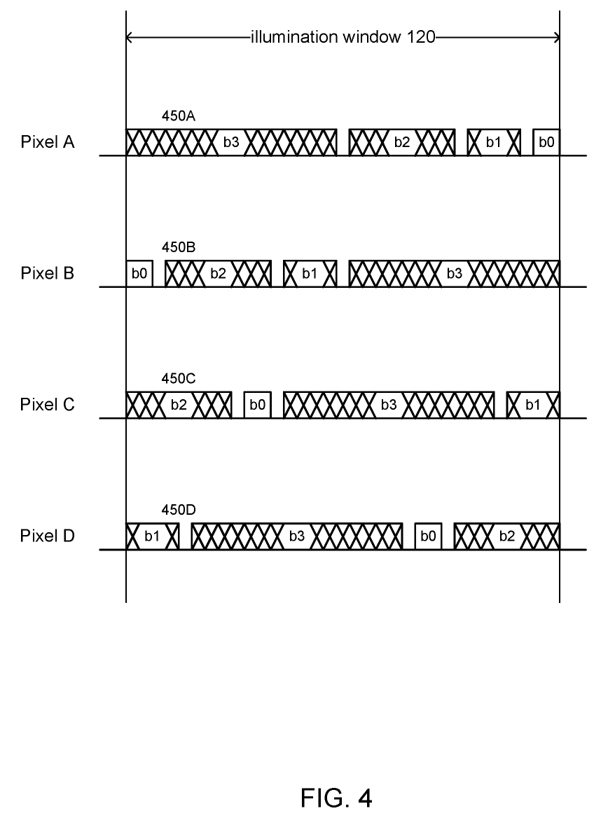

In another variation, the order of the pulses may also vary beyond just shifting. FIG. 4 shows an example in which the pulse orders have a random order of pulses. Pulse orders 450A, B, C, D are for the bit orders b3-b2-b1-b0, b0-b2-b1-b3, b2-b0-b3-b1 and b1-b3-b0-b2. In this example, the time slots for bit b3 are distributed to different positions throughout the illumination window to reduce peak current draw. The set of pulse orders may be optimized to reduce current draw. If the images being displayed have some known structure or non-random characteristics, those may also be considered in determining the set of pulse orders.

The pulse orders may also be determined dynamically, for example based on the actual bit codes as the images are rendered. Algorithms may be used to reduce the temporal alignment of pulses given the actual bit codes, or to reduce the number or duration of situations when the number of pulses that are on exceed some threshold. The threshold may be based on when the display would overdraw current.

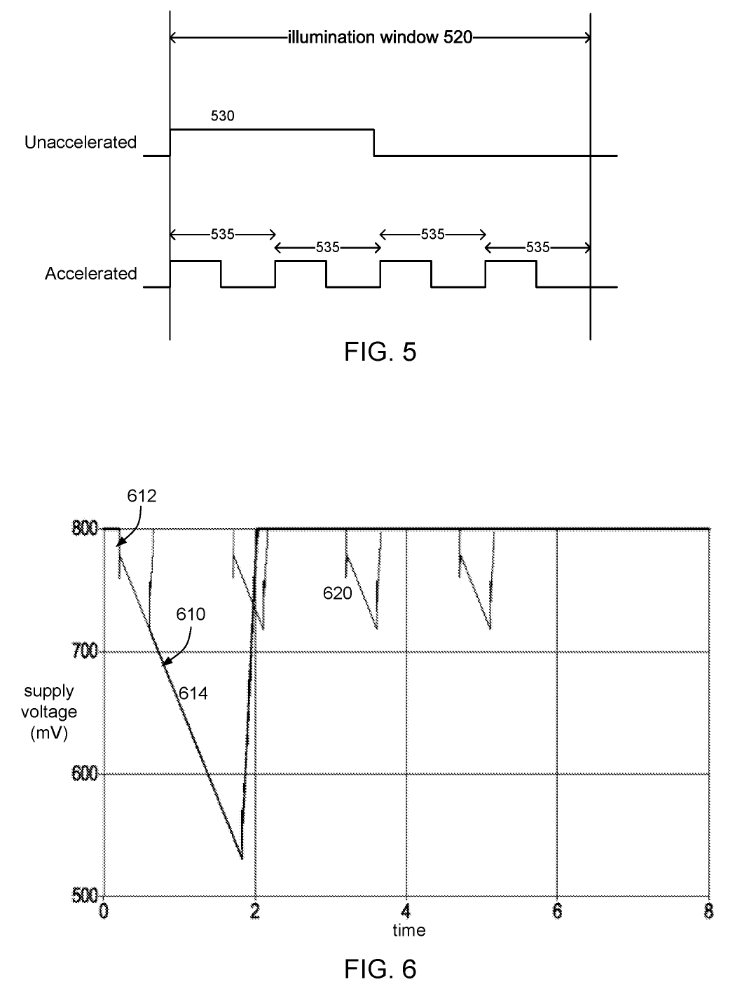

Another way to reduce peak current is referred to as accelerated illumination, as shown in FIG. 5. In accelerated illumination, the pattern of pulses is sped up and repeated k times, where k is an integer greater than or equal to two. The duration of the sped up pattern is 1/k times the duration of the original pattern. The top row of FIG. 5 shows a base pattern 530 implementing a bit code 1000 within an illumination window 520. In the bottom row, this pattern is sped up by a factor of four (k=4) and repeated four times 535. Speeding up by a factor of four means that the time units in the pattern are shortened by a factor of four. Accelerated illumination spreads the pattern more evenly over the available illumination window. The most significant bit is not implemented as a single long pulse. Rather, it is divided into four shorter pulses separated from each other. This is also true for all the other bits. Accelerated illumination may be implemented by speeding up the clock for the pulses.

Separate from power supply considerations, accelerated illumination may also be useful for removing artifacts stemming from relative movement between a display and an observer’s eye. These artifacts can occur because, under some conditions, rapid eye motion can effectively sample a display at speeds approaching its frame rate.

FIG. 6 illustrates the effect of accelerated illumination in a display. The graph in FIG. 6 is a plot of supply voltage to the pixel array as a function of time. In this example, the group of pixels all use the same pulse order. For the pattern shown in FIG. 6, the pixels are all on for the first 20% of the illumination window and then all turn off. The power supply can provide a maximum of 0.9A and the peak load is 1A if all the pixels are on at the same time. Coupling capacitors are used to buffer current overdraw situations. That is, if more than 0.9A is required, the coupling capacitors can provide the overcurrent. They are then recharged when the current load reduces.

Curve 610 shows the power supply voltage when accelerated illumination is not used. When all pixels are on, the display draws 1A current. This results in an initial voltage drop 612 due to the equivalent series resistance of the coupling capacitors, followed by further reduction 614 over time as the display discharges the coupling capacitors. The supply voltage output decreases from 0.8V to about 0.53V, which is an unacceptably large drop.

Curve 620 shows the power supply voltage when accelerated illumination is used. The 20% on time is separated into four blocks of 5% on time. The supply voltage still drops during these blocks, but not as much since the duration of the blocks is shorter. The supply voltage recovers in the time between blocks. In this example, the power supply voltage output decreases from 0.8V to about 0.72 V, which is significantly better performance than for curve 610.

Another way to reduce peak current is to vary the illumination window. If different pixels have different illumination windows, then their pulses may be non-aligned even if they use the same pulse orders within the illumination window. Assume that pulse orders are determined on a row basis, and all pixels in a row use the same pulse order. Rolling illumination may be used in which each row of pixels has a progressively offset illumination window. In group illumination, rows are grouped together. Rows in each group have the same illumination window, but different groups may use different offset illumination windows. The techniques described above may be used to vary the pulse orders for rows within a group.

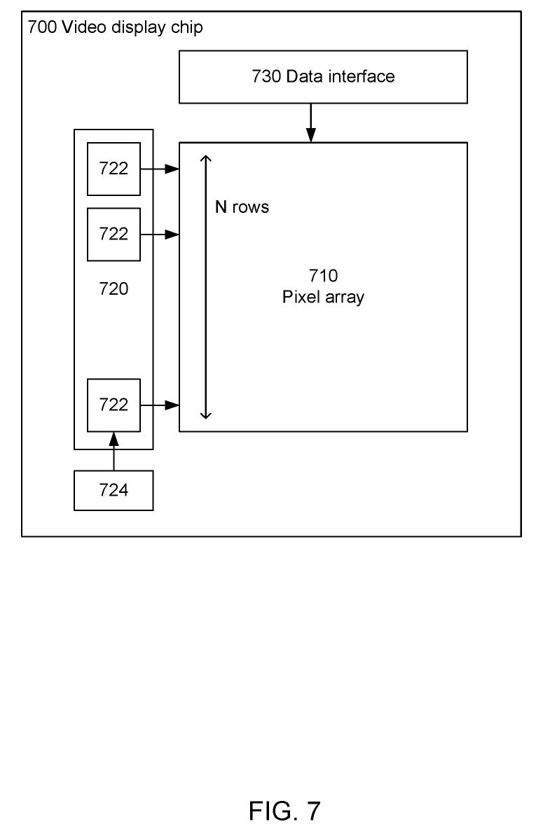

FIG. 7 is a block diagram of an integrated circuit video display chip 700. This example is manufactured on a single die. The die contains an array 710 of pixels (e.g., micro-LEDs). The die also contains a controller 720, which implements the PWM pulse patterns on a row basis. In this example, the controller 720 is a set of state machines 722. Each state machine determines the pulse orders for a group of rows of pixels. The same pulse order is used for all pixels in a row. The timing pattern for the pulses may be clocked by clock 724. The clock may be sped up to implement accelerated illumination. In one approach, the controller 720 constructs the timing pattern by determining the pulse order and separating the time slots for each of the pulses by a gap period, as shown in FIG. 1. The bit codes for the pulses are received via interface 730. The bit codes may be read into the pixel array using conventional array techniques. Pulses may be generated by applying power to the pixels, gated by the timing pattern from controller 720 and the bit codes read through interface 730.

Although the detailed description contains many specifics, these should not be construed as limiting the scope of the invention but merely as illustrating different examples. It should be appreciated that the scope of the disclosure includes other embodiments not discussed in detail above. Various other modifications, changes and variations which will be apparent to those skilled in the art may be made in the arrangement, operation and details of the method and apparatus disclosed herein without departing from the spirit and scope as defined in the appended claims. Therefore, the scope of the invention should be determined by the appended claims and their legal equivalents.

What is claimed is:

1. A method for driving pixels in a video display using pulse width modulation, the method comprising:
receiving bit codes that specify pulses that drive at least two different pixels of a video display; wherein the bit codes specify which pulses are on or off within illumination windows for the different pixels, and the illumination windows for the different pixels are temporally aligned; and
generating the pulses from the bit codes; wherein an order of the pulses within the illumination windows is different for the different pixels.

2. The method of claim 1 wherein the order of the pulses within the illumination window is shifted by one pulse between adjacent pixels.

3. The method of claim 1 wherein the order of the pulses within the illumination window is shifted by a random but different number of pulses for the different pixels.

4. The method of claim 1 wherein the order of the pulses within the illumination window is different and not just shifted for the different pixels.

5. The method of claim 1 wherein the order of the pulses within the illumination window is random but different for the different pixels.

6. The method of claim 1 wherein the order of the pulses within the illumination window is determined dynamically based on the bit codes.

7. The method of claim 6 wherein the order of the pulses within the illumination window is determined further based on reducing temporal alignment of the pulses.

8. The method of claim 6 wherein the order of the pulses within the illumination window is determined further based on reducing a current overdraw by the video display.

9. The method of claim 1 wherein generating the pulses from the bit codes comprises:
replicating the patterns of pulses k times within the illumination window, k ≥ 2, with each replicated pattern having a duration 1/k times a duration of the pattern before replication.

10. The method of claim 1 wherein the bit code has N bits, and the pulses have a width of 2ⁿ(Δ), where Δ is a unit width and n=0 to (N-1).

11. The method of claim 1 wherein all pixels in the video display have the same illumination window.

12. The method of claim 1 wherein the pixels are part of a group of pixels that all have the same illumination window, but different groups have different illumination windows.

13. A video display chip comprising a single die containing:
an array of pixels that are driven by pulses that occur within illumination windows for the pixels, wherein the illumination windows for at least two different pixels are temporally aligned; and
a controller that determines an order of the pulses within the illumination windows, wherein the order of the pulses within the illumination windows is different for the different pixels.

14. The video display chip of claim 13 wherein the array of pixels is arranged as rows of pixels, and the controller uses the same order of the pulses for all pixels in a row.

15. The video display chip of claim 13 wherein the controller generates timing patterns as time slots in the order of the pulses and separated by a gap period.

16. The video display chip of claim 13 wherein the controller comprises a state machine.

17. The video display chip of claim 13 wherein the patterns of pulses are determined by bit codes that specify which pulses are on or off, and the single die further contains:
a data interface to provide the bit codes to the pixels in the array.

18. The video display chip of claim 13 wherein the array of pixels comprises an array of LEDs, and the single die further contains:
driver circuitry that provides current to drive the LEDs according to the pulses.

19. The video display chip of claim 18 further comprising:
a power supply that provides power to the driver circuitry, wherein the power supply exhibits less voltage drop when the order of the pulses is different for the different pixels than when the order of the pulses is the same for the different pixels.

20. A method for driving pixels in a video display, the method comprising:
receiving bit codes that specify pulses that drive at least two different pixels of a video display; wherein the pulses occur within an illumination window that is the same for the different pixels; and
generating the pulses from the bit codes, wherein an order of the pulses within the illumination window is different for the different pixels.
